(19) United States
(12) Patent Application Publication
(10) Pub. No.: US 2014/0317560 A1
(43) Pub. Date: Oct. 23, 2014

(54) MAP DISPLAY CONTROL DEVICE AND NAVIGATION DEVICE USING THE SAME

(71) Applicant: Koji Hashimoto, Tokyo (JP)

(72) Inventor: Koji Hashimoto, Tokyo (JP)

(73) Assignee: Mitsubishi Electric Corporation, Tokyo (JP)

(21) Appl. No.: 14/357,357

(22) PCT Filed: Jan. 5, 2012
(86) PCT No.: PCT/JP2012/050052

§ 371 Date: May 9, 2014

(51) Int. Cl. G06F 3/0484

(52) U.S. Cl. CPC G06F 3/04847
USPC 715/788

(57) ABSTRACT

A map display control device includes an instruction input unit capable of receiving input of a user instruction including an instruction to change display to a map according to purpose, an information drawing unit that acquires a map information including map display information to be displayed on a display, is capable of automatically setting a density of the map display information according to the purpose of the map, and processing the map information in accordance with the map and the density of the map display information set according to the purpose of the map, on the basis of the instruction to change display, and a display controller outputting an instruction signal on the basis of an instruction from the information drawing unit to display the map as changed on the display at the density of the map display information that is set according to the purpose of the map.

### TECHNICAL FIELD

The present invention relates to a map display control device for displaying different maps corresponding to different purposes and a navigation device using the map display control device.

### BACKGROUND ART

Patent Document 1 discloses a conventional current location display apparatus for a mobile unit, in which street-level map information is read out and a map with a high level of detail is displayed on a screen when the travelling speed of a mobile unit is in a low-speed area, city-level map information is read out and a map with a normal level of detail is displayed on the screen when the travelling speed of a mobile unit is in a medium-speed area, and prefecture-level map information is read out and a map with a low level of detail is displayed on the screen when the travelling speed of a mobile unit is in a high-speed area.

Patent Document 2, similarly to Patent Document 1, discloses technology that enables an information amount of various data that is displayed on a map around a vehicle location mark 24 to be manually adjusted by appropriately operating a zoom-in key 16 or a zoom-out key 17, as shown in FIG. 2, for example.

### PRIOR ART DOCUMENTS

### Patent Document

Patent Document 1: Japanese Patent Application Laid-Open No. 12-130412 (1990) (lines 1 to 10 in upper right column of page 3)
Patent Document 2: Japanese Patent Application Laid-Open No. 2004-163525 (paragraph 0024 and FIGS. 2 and 3 or paragraph 0028 and FIGS. 2 and 4)

### SUMMARY OF INVENTION

### Problems to be Solved by the Invention

As described above, the aforementioned Patent Documents 1 and 2 propose to change the level of detail of map information. However, Patent Documents 1 and 2 both discuss only a map around the current location and fail to disclose or suggest changing the purpose of map display or setting the density of map display information according to the purpose of displaying various maps.

In other words, information that the map display control device is instructed to display is not limited to information regarding the area around the current location, and includes various types of information such as information regarding the area around the current location, information regarding the area around a desired facility after a facility search, information regarding the area around a destination after destination setting, and information regarding the entire route from the current location to the destination. However, neither Patent Document 1 nor Patent Document 2 gives consideration to setting an appropriate density of map display information according to the purposes of displaying different types of information.

In view of this, the present invention involves outputting an instruction signal on the basis of a user instruction to change display to a map according to purpose so that information is displayed on a display in accordance with the map and the density of map display information that is set according the purpose of the map.

### Means for Solving the Problems

A map display control device according to the present invention includes a map information storage that stores map information including map display information to be displayed on a display, an instruction input unit that is capable of receiving input of a user instruction that includes an instruction to change display to a map according to purpose, an information drawing unit that is capable of setting a density of the map display information according to the purpose of the map, and processes the map information in accordance with the map and the density of the map display information set according to the purpose of the map, on the basis of the instruction to change display, and a display controller that outputs an instruction signal on the basis of an instruction from the information drawing unit to display the map as changed on the display at the density of the map display information that is set according to the map.

A navigation device according to the present invention includes a map information storage that stores map information including map display information to be displayed on a display, an instruction input unit that is capable of receiving input of a user instruction that includes an instruction to change display to a map according to purpose, an information drawing unit that is capable of setting a density of the map display information according to the purpose of the map, and processes the map information in accordance with the map and the density of the map display information set according to the purpose of the map, on the basis of the instruction to change display, a display controller that outputs an instruction signal on the basis of an instruction from the information drawing unit to display the map as changed on the display at the density of the map display information that is set according to the map, and a display that displays information upon receiving an instruction signal from the display controller.

### Advantageous Effects of the Invention

With the map display control device according to the present invention, it is possible to output an instruction signal on the basis of a user instruction to change display to a map according to purpose so that information is displayed on a display in accordance with the map and the density of map display information that is set according the purpose of the map.

With the navigation device according to the present invention, it is possible to, on the basis of a user instruction to change display to a map according to purpose, display information on a display in accordance with the map and the density of map display information that is set according the purpose of the map.

### BRIEF DESCRIPTION OF DRAWINGS

FIG. 1 illustrates an overall configuration including the configuration of a map display control device, which represents Embodiment 1 of the present invention, and the configuration of an on-board navigation composite device using the map display control device.

FIG. 2 shows an example of a menu screen of the map display device according to Embodiment 1 and an example of screen transition through operations on each screen.

FIG. 3 schematically illustrates a hierarchical set of map information pieces that are commonly used in an on-board navigation composite device.

FIG. 4 shows an example of maps displayed respectively using upper-level map information and lower-level map information of the hierarchical set of map information pieces commonly used in the on-board navigation composite device.

FIG. 5 shows an example of maps displayed respectively using upper-level map information and lower-level map information according to Embodiment 1 of the present invention.

FIG. 6 shows an example of the relationship between a map display range of a display 16 and parcels of map information according to Embodiment 1 of the present invention.

FIG. 7 is a flowchart of operations according to Embodiment 1 of the present invention.

FIG. 8 shows an example of Embodiment 1 of the present invention in which four parcels of lower-level map information are compressed to fit the display range of a display.

FIG. 9 is a diagram illustrating a map of the entire route indicated by links and nodes according to Embodiment 1 of the present invention.

FIG. 10 shows an example of Embodiment 2 of the present invention in which a quarter of a parcel of upper-level map information is expanded to the display range of the display.

### DESCRIPTION OF EMBODIMENTS

### Embodiment 1

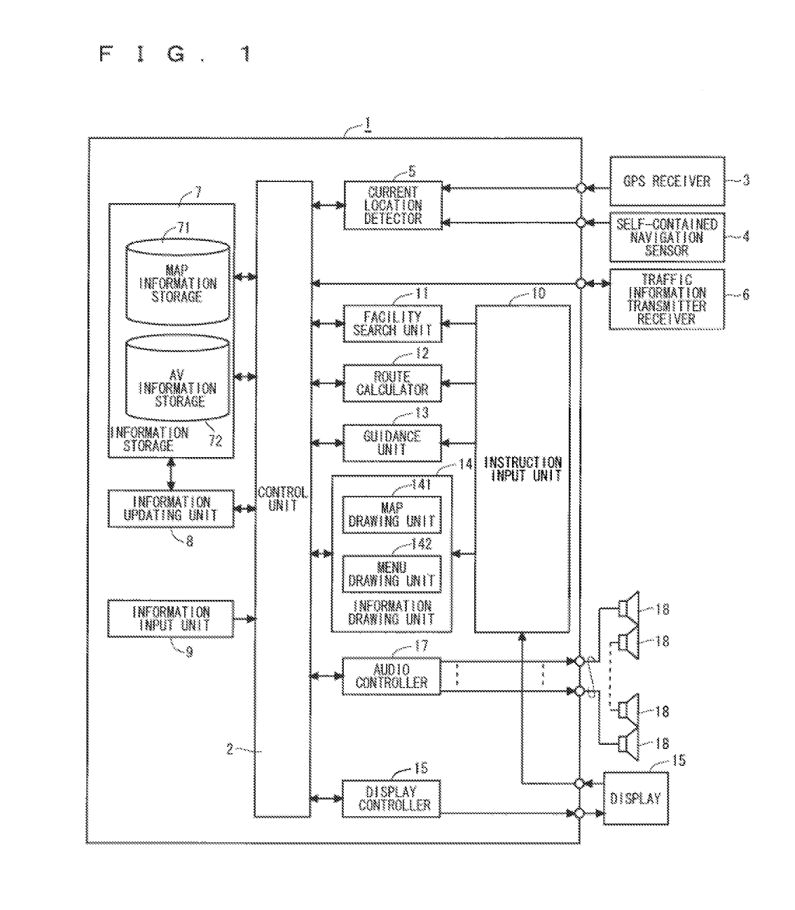

FIG. 1 illustrates an overall configuration including the configuration of a map display control device of Embodiment 1 for implementing the present invention and the configuration of a navigation device using the map display control device. In particular, FIG. 1 shows an example in which the map display control device is applied to an on-board navigation device. Recent primary on-board navigation devices are multifunctional devices in which a navigation device and an AV (Audio Visual) device operate in cooperation with each other. Here, an on-board navigation composite device in which the navigation device and the AV device operate in cooperation with each other will be described as an example.

Although described later in detail, the map display control device 1 shown in FIG. 1 includes a control unit 2 that controls overall operations of the map display control device, a current location detector 5 that obtains the current location and travel direction of the vehicle upon receipt of a signal from a GPS receiver 3 and a self-contained navigation sensor 4, a traffic information transmitter/receiver 6 that transmits and receives traffic information, and an information storage 7 that stores various types of information. The map display control device 1 also includes an information updating unit 8 that updates the information stored in the information storage 7 on the basis of an instruction received from the control unit 2, an information input unit 9 that receives information regarding a map or information regarding AV from the outside, an instruction input unit 10 that accepts a user instruction, and a facility search unit 11 that searches for a desired facility or place. The map display control device 1 further includes a route calculator 12 that calculates a desired route to reach a point desired by the user, and a guidance unit 13 that provides guidance information regarding the direction of travel at predetermined key points so that the user will not get lost while driving. The map display control device 1 also includes an information drawing unit 14 that performs information processing for drawing a map or guidance information and for visually providing settings of various functions of the on-board navigation composite device as a menu, a display controller 15 that receives a result of the information processing performed by the information drawing unit 14 and gives an instruction to display that result on an externally connected display 16, and an audio controller 17 that receives information regarding audio such as AV information or guidance information and outputs audio through externally connected speakers 18.

The GPS receiver 3 is provided to apply a satellite navigation system for measuring the current location of a vehicle, using radio waves from GPS satellites. The self-contained navigation sensor 4 is provided to apply a self-contained navigation system for detecting the current location and orientation of the vehicle, using various types of sensors. The self-contained navigation sensor 4 includes, for example, a direction sensor for detecting the orientation of the vehicle and an odometer sensor for detecting the number of revolutions of wheels to detect the distance traveled. The current location detector 5 is configured to, upon receipt of signals from the GPS receiver 3 and the self-contained navigation sensor 4, detect the current location and travel direction of the vehicle using both the satellite navigation system and the self-contained navigation system, through map matching based on map information described later. “Map matching” as used herein refers to a technique of considering, for example, road information included in later-described map information and the travel path of the vehicle including right and left turns and comparing such information with the detected current location of the vehicle so as to estimate the most probable location as the current location of the vehicle. Although Embodiment 1 describes a case of employing a hybrid system using both the satellite navigation system and the self-contained navigation system, only one of the navigation systems may be employed. The traffic information transmitter/receiver 6 is configured to receive or transmit traffic information sequentially or at predetermined time intervals. Specifically, the traffic information transmitter/receiver 6 receives traffic information (typified by Vehicle Information and Communication System (VICS) (registered trademark)) provided by FM multiplex broadcasting, a radio wave beacon, or an optical beacon and obtains information including traffic jam conditions, traffic jam length, traffic regulations, and required travel time for each route. As for the traffic information transmitter/receiver 6, Dedicate Short Range Communication (DSRC) has also been adopted in recent years, and thus a variety of services can be offered to the user by using DSRC in two-way or one-way communication between a roadside unit and an on-board unit. The traffic information transmitter/receiver 6 functions as a transmitter for transmitting traffic information in the case where, for example, the traffic information transmitter/receiver 6 transmits information regarding the vehicle, e.g., information called “probe information” such as the current location, the travelling speed, and other pieces of information. If traffic information is not transmitted or received interactively, the traffic information transmitter/receiver 6 may be replaced by a traffic information receiver.

The information storage 7 is configured to store information necessary for navigation or entertainment functionality and typically includes a map information storage 71 that stores map information and an AV information storage 72 that stores audio information and/or video information. These storages are memory devices, for example. The map information storage 71 includes, as map information, a hierarchical set of a plurality of map information pieces that correspond respectively to predetermined scales. These map information pieces include map display information. Map display information as used herein refers to information that includes at least one of “road information” regarding roads, “facility information” (e.g., type, name, and location) regarding facilities, “various types of character information” (e.g., names of places, facilities, intersections, and roads), and “various types of icon information” representing facility numbers, road numbers, and so on, and is displayed on a display 16. Note that the map information stored in the map information storage 71 also includes guidance information (e.g., information regarding predetermined key points, drawing information for key points, and audio guidance information) for use in the guidance unit 13, and data information that is not displayed on the display 16 (e.g. a wide variety of information such as information indicating each road by line segments called “links” and points called “nodes”, link costs indicating loads required to travel such links, and other pieces of information). A typical example of the information storage 7 is a hard disk drive (HDD), but other memory devices using semiconductor devices may be used as the information storage 7. Note that the map information and AV information stored in the information storage 7 can be changed, and they can be partially updated, added or deleted or fully deleted or updated by the information updating unit 8 upon receipt of an instruction from the control unit 2.

The information input unit 9 is configured to supply the map information or the AV information to the on-board navigation composite device. In other words, the information input unit 9 can be used to update the information stored in the information storage 7 upon receiving information from the outside. Alternatively, the information input unit 9 may itself function as the information storage 7 while receiving information from the outside. Here, specific examples of the information that the information input unit 9 receives from the outside include the map information and the AV information. The information input unit 9 is provided with an insertion unit that receives a medium including the map information and/or the AV information, such as a disk medium typified by a CD-ROM or DVD or a semiconductor medium typified by an SD card, and is configured to read the map information and the AV information from a medium inserted in the insertion unit. At this time, information in such a medium may be stored in the information storage 7, or the information input unit 9 may use information in such a medium and function as an information storage, rather than providing the information storage 7. As a variation on the information input unit 9, a configuration is also conceivable in which the information input unit 9 is a connection terminal such as a USB and is connected directly or via a cable to a portable medium that includes information. Note that such a portable medium may be a portable music player or a medium having functionality as a music player. The information input unit 9 and a portable information communication device such as a mobile phone or a portable tablet may be connected via a cable, but they do not necessarily have to be connected physically and may be connected to each other wirelessly to exchange information. The term “wireless” as used herein refers to a connection that is not via a cable, as compared to wired connection, and any method (e.g., method using radio waves or optical method) for exchanging information is applicable.

The information input unit 9 may include a communication device that exchanges information with a separately installed information center and may be configured to exchange either of the aforementioned map information and AV information or other information via this communication device. Instead of including such a communication device, the information input unit 9 may use the aforementioned portable information communication device.

The instruction input unit 10 is configured to receive a user instruction and input the user instruction to the on-board navigation composite device. All user instructions are input through various means, such as hardware switches provided in the on-board navigation composite device, touch switches that are set and displayed on the display, which will be described later, a recognition device that recognizes instructions input through a remote controller provided on a handle or the like or a separate remote controller, and a speech recognizer that recognizes instructions given by the user's voice.

The facility search unit 11 is configured to search for a desired facility on the basis of the facility information stored in the map information storage 71. Specifically, the facility search unit 11 searches the map information stored in the map information storage 71 for a desired facility or place on the basis of the user instruction received via the instruction input unit 10. The search result of the facility search unit 11 is displayed on the display 16 or the like and presented to the user.

The route calculator 12 is configured to calculate an optimum route (hereinafter, referred to as a “recommended route”) from the current location of the vehicle to a point set by the user (e.g., a destination or an area on route to the destination). Specifically, the route calculator 12 obtains the current location of the vehicle from the current location detector 5, calculates a recommended route on the basis of point information input from the instruction input unit 10 and the map information obtained from the map information storage 71, and gives an instruction to display the calculated recommended route on the display 16 so that the recommended route is presented to the user. As one example of the method for calculating a route, the route calculator 12 uses a known Dijkstra's algorithm in which link costs assigned respectively to links that each represent a road by a line segment are accumulated so as to compute a route with the minimum link cost. Note that, as an example of the recommended route, a route that is the shortest in distance (shortest route), a route with the shortest required time (fastest route), a route that is the cheapest including expressway/road tolls (cheapest route), a route selected as being the most fuel efficient (fuel-efficient route), and a route that balances time and cost (standard route) may also be selected, for example. Alternatively, a plurality of mutes may be presented for each of the above options (e.g., a plurality of “shortest routes”). In this case, not all the presented routes are necessarily the shortest route, and multiple routes are presented within a certain degree of tolerance. The same applies to other options (e.g., fastest route, lowest-cost route, fuel-efficient route, and standard route).

The guidance unit 13 is configured to assist the user's driving operations at predetermined key points such as points including intersections and forks where the vehicle needs to change direction when driving on the recommended route, easily mistaken points, and points where the vehicle driving on a road with multiple traffic lanes is guided to change lanes to a predetermined traffic lane in advance in consideration of an upcoming right or left turn. The guidance unit 13 obtains the current location of the vehicle from the current location detector 5, acquires a recommended route from the route calculator 12 as well as the guidance information included in the map information from the map information storage 71, and when the vehicle has reached a predetermined distance before a predetermined key point such as an intersection at which the vehicle needs to change direction, visually indicates a direction in which the vehicle is to move at the intersection with an arrow or by coloring a lane and gives an instruction to output an enlarged guide map obtained through enlargement or enlargement and deformation, for example. Alternatively, the guidance unit 13 gives an instruction to visually indicate a direction in which the vehicle is to move and output an actual image of that key point or an image resembling the key point.

The information drawing unit 14 is configured to give an instruction to output drawing information for drawing various types of desired information such as characters and images on the display 16. The information drawing unit 14 includes at least a map drawing unit 141 that processes the aforementioned map information on the basis of a user instruction and draws a desired map. In Embodiment 1, the information drawing unit 14 also includes a menu drawing unit 142 that manages the state of a menu screen and draws the menu screen.

Although its specific operations will be described later, the map drawing unit 141 acquires necessary information from the map information storage 71, the current location detector 5, the facility search unit 11, the route calculator 12, the guidance unit 13, and the menu drawing unit 142, processes information to be displayed on the display 16, and outputs the result of the processing to the display controller 15. Upon receipt of the output from the map drawing unit 141, the display controller 15 outputs an instruction to draw a desired map on the display 16 connected to the display controller IS. The display 16 draws desired information on the screen on the basis of the instruction received from the display controller 15.

The menu drawing unit 142 is configured to display a menu on the basis of a user instruction obtained from the instruction input unit 10, and gives an instruction to draw a desired menu on the display 16, via the display controller 15. Drawing the menu involves setting touch switches on the screen displayed on the display 16. When the user operates a touch switch, this user operation is recognized by the instruction input unit 10.

The display controller 15 is capable of outputting an instruction to draw image information stored in the AV information storage 72 on the display 16.

The audio controller 17 is capable of giving an instruction to output the guidance information received from the guidance unit 13 in the form of audio. Note that there are a plurality of speakers 18, and the audio controller 17 controls one of the speakers that is close to the driver's seat to be used when outputting the guidance information. All of the speakers 18 do not necessarily have to be the same and may have different structures and different functions, with some of the speakers 18 being for mainly outputting high-pitched notes, some being for mainly outputting middle-pitched notes, and some being for mainly outputting low-pitched notes. Those speakers that are used to output the guidance information are desirably configured to mainly output middle-pitched notes in consideration of ease of hearing. Alternatively, the on-board navigation composite device may include speakers for outputting the guidance information, separately from the speakers 18 for outputting the AV information.

The audio controller 17 is also configured to give an instruction to output the audio information stored in the AV information storage 72 or the audio information obtained from the information input unit 9 to each of the speakers 18 by appropriately allocating the audio information to the speakers 18. When the information obtained from the AV information storage 72 or the information input unit 9 includes both audio information and video information, such as a television broadcast or a DVD, the audio controller 17, by giving an instruction to output the audio information to the speakers 18, and the display controller 15, by giving an instruction to output the video information to the display 16, operate in cooperation with each other to implement entertainment functionality.

Although the above describes an example in which various representative functions are implemented independently of the control unit 2, functions such as the current location detector 5, the information updating unit 8, the facility search unit 11, the route search unit 12, the guidance unit 13, the information drawing unit 14, the display controller 15, and the audio controller 17 may be included in the control unit 2 and may be implemented using a microcomputer, for example. The information drawing unit 14 and the display controller 15 may be provided integrally.

Note that the on-board navigation composite device may operate independently on the basis of the map information stored in the map information storage 71, or may operate using a communication system, in which case a necessary range of map information is obtained by communication when necessary and is temporarily stored and used in an internal work memory such as a DRAM.

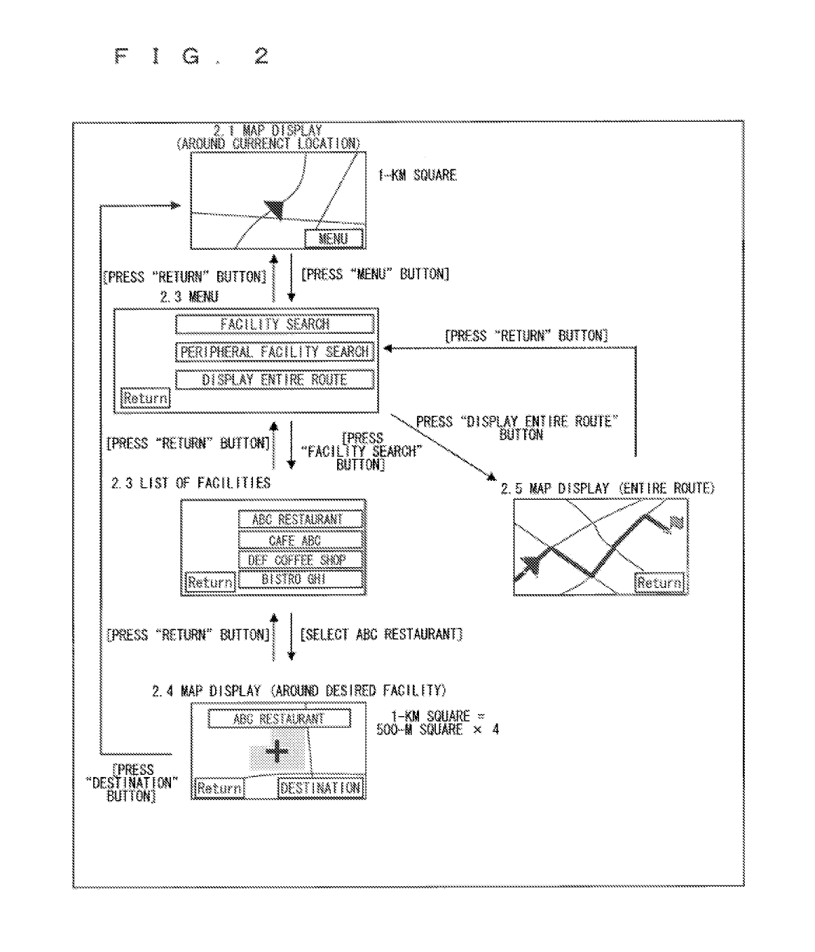

Next is a description of the concept of Embodiment 1 with reference to FIG. 2.

In FIG. 2, a map 2.1 around the current location, a map 2.4 around a desired facility, and a map 2.5 of the entire route are shown and will be described below. These maps merely result from changing the display target and do not indicate that separate maps are stored.

FIG. 2 shows an example of the menu screen of the map display device of Embodiment 1 and an example of instructions to change a map according to purpose through operations on each screen, i.e., an example of screen transition. The display of the menu screen or a desired map described below is implemented by the instruction input unit 10 receiving a user instruction to change display to a map, the information drawing unit 14 performing processing in accordance with the user instruction, and the display controller 15 giving the result of the processing as an instruction signal to the display 16. The map 2.1 in FIG. 2 is displayed when displaying the area around the current location is selected as the purpose of map display, and displays a 1-km square area centered approximately on the vehicle, for example. The current location of the vehicle at this time is computed by the current location detector 5 on the basis of the information received from the GPS receiver 3 or the self-contained navigation sensor 4 or the like. Note that the actual display 16 normally has a wide screen and is not limited to having a display range of a square shape (1-km square), but in Embodiment 1, the display range is assumed to be square in shape in order to simplify description. It is thought that the map 2.1 around the current location will be most frequently displayed in the use of the on-board navigation composite device. Here, a menu button in the lower right part of the map 2.1 is a touch switch that is set on the display screen of the display 16, and the map 2.1 around the current location transitions to a menu screen 2.2 for selecting functionality by pressing the menu button. In the description of Embodiment 1, a user operation on a touch switch is given as an example of the input of an instruction to the instruction input unit 10.

The menu screen 2.2 displays, by way of example, touch switches for executing three functions, namely “Facility Search,” “Peripheral Facility Search,” and “Display Entire Route” and a touch switch “Return” for returning to the map 2.1 around the current location. It should additionally be noted that screens to be selected and displayed by the on-board navigation composite device are not limited to those displayed on the menu screen 2.2 and that various screens can be included as examples, such as a screen for the area around the destination, a screen for an area on route to the destination, and a screen for the area around the user's house.

A screen 2.3 is a facility list screen that is displayed by pressing the “Facility Search” button in the menu screen 2.2 and displays the result of the facility search. Although the details will not be described here, there are various types of methods for searching for a facility, such as a method of narrowing down candidates using the type and geographical location of a desired facility as conditions, as well as using the facility information stored in the map information storage 71 in accordance with a user instruction from the instruction input unit 10. This facility search is conducted by the facility search unit 11. When a desired facility selected as a result of the facility search is set as a destination in accordance with a user instruction, the route calculator 12 calculates a recommended route from the current location of the vehicle to the desired facility, and the guidance unit 13 calculates guidance necessary at predetermined key points on the recommended route. These calculation results are given to the information drawing unit 14, together with the current location of the vehicle obtained by the current location detector 5, and are appropriately displayed on the map being displayed or on a screen for guidance information that is switched to from the map when the vehicle has reached a predetermined key point. On the basis of the guidance information from the guidance unit 13, audio guidance is also provided at a predetermined key point through some of the speakers 18 via the audio controller 17.

The screen 2.4 shows an example of the case where displaying the area around a facility is selected as the purpose of map display by pressing a touch switch for the ABC restaurant in the facility list screen 2.3 so that the facility list screen 2.3 transitions to the screen 2.4 displaying the map around the desired facility. Here, a map centered on the ABC restaurant serving as the desired facility is displayed. This map is for use in applications such as searching for a parking lot around the ABC restaurant. Displaying the area around the facility requires more map display information. Accordingly, a map having a higher density of map display information than that of the map 2.1 around the current location is automatically displayed, that is, more map display information is automatically displayed on the display 16. This is achieved by, upon receipt of a user instruction to change display from the map 2.1 around the current location to the map 2.4 around the desired facility, changing the map currently being displayed to the map 2.4 around the desired facility as well as changing the density of map display information according to the purpose of the map display.

Description will now be given regarding the relationship between the map scale, i.e., the display range of the display screen, and the density of map display information. In order to simply the description, it is assumed that the display range of the map 2.1 around the current density and the display range of the map 2.4 around the ABC restaurant are both a 1-km square. In other words, it is assumed that the map 2.1 around the current location and the map 2.4 around the ABC restaurant are both displayed using the same level of map information. At this time, in the case of displaying the map 2.1 around the current location, more map display information than is necessary is undesirable in consideration of ease of reading the recommended route or the map. On the other hand, in the case of displaying the map 2.4 around the ABC restaurant, it is desirable to display a large number of pieces of more detailed map display information, which is typified by road information such as narrower streets, character information such as the names of places, more detailed facility information, and various types of icon information (e.g. gas stations, banks, convenience stores, and parking lots), than in the case of displaying the map 2.1 around the current location in order to search for a parking lot or the like around the ABC restaurant. In other words, the density of map display information that is appropriate for displaying the map 2.1 around the current location on the display 16 is insufficient for displaying the map 2.4 around the ABC restaurant.

At this time, it is possible to obtain more detailed map display information by changing settings such that the map scale is changed to display a more detailed map. However, in this case, the display range of a map to be displayed on the screen of the display 16 will be a 500-meter square, for example, and the user will no longer be able to reference a large number of parking lots at the same time, making it difficult to grasp the positional relationship therebetween.

In view of this, in Embodiment 1, when, in the case where the same scale is selected for both of the map 2.1 around the current location and the map 2.4 around the ABC restaurant, a user gives an instruction to change a map displayed on the screen from the map 2.1 around the current location, which is, for example, a 1-km square map, to the map 2.4 around the ABC restaurant, which is a 1-km square map, the density of map display information is automatically increased for display from the density of map display information used to display the map 2.1 around the current location while maintaining a state in which a 1-km square map is displayed on the screen. This makes it possible to display more map display information such as various types of icon information, road information, facility information, and various types of character information and to automatically obtain a more desirable map while minimizing user operations.

Next is a description of the concept for implementing the aforementioned technical effects.

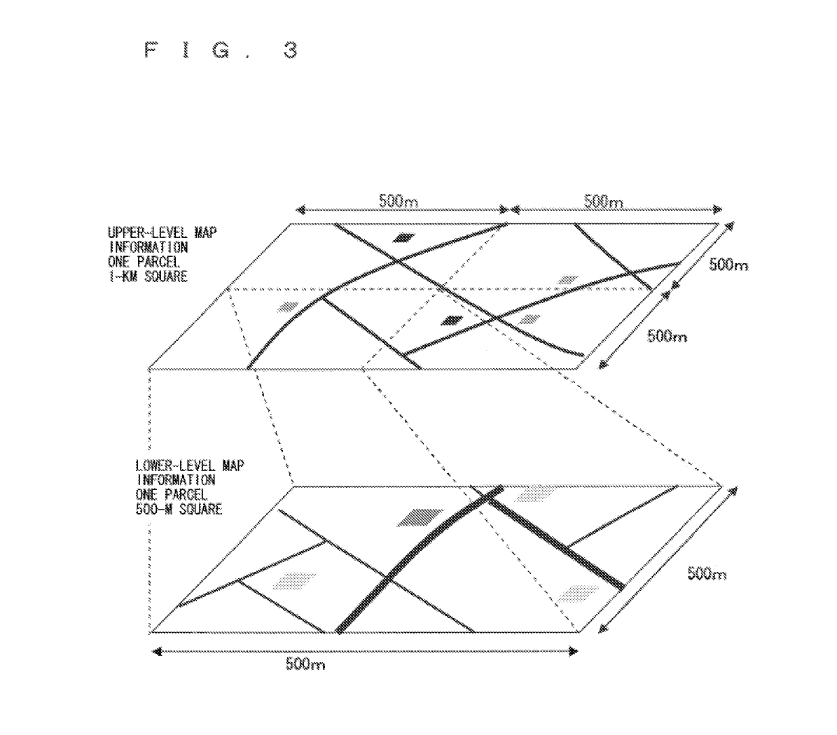

The map information storage 71 described above with reference to FIG. 1 stores the map information including the map display information such as road information, facility information, icon information, and character information. This indicates that the map information storage 71 stores a hierarchical set of map information pieces that correspond respectively to different predetermined scales. Map information pieces at lower levels correspond to larger scale maps (more detailed maps) and include more map display information. FIG. 3 schematically illustrates a hierarchical set of map information pieces that are commonly used in the on-board navigation composite device. Although only two levels are shown in FIG. 3, in actuality, there are approximately 10 levels of map information pieces corresponding to different predetermined scales from a wide range to a narrow range. The density of the map display information for each level displayed on the display 16 is substantially the same. In other words, the amount of map display information increases as the map scale is increased to show a narrower range and the level of the map information is reduced to a lower level. However, reducing the level of the map information narrows the display range of the display 16, and ultimately, there is little change in the amount of map display information that is displayed on the display 16.

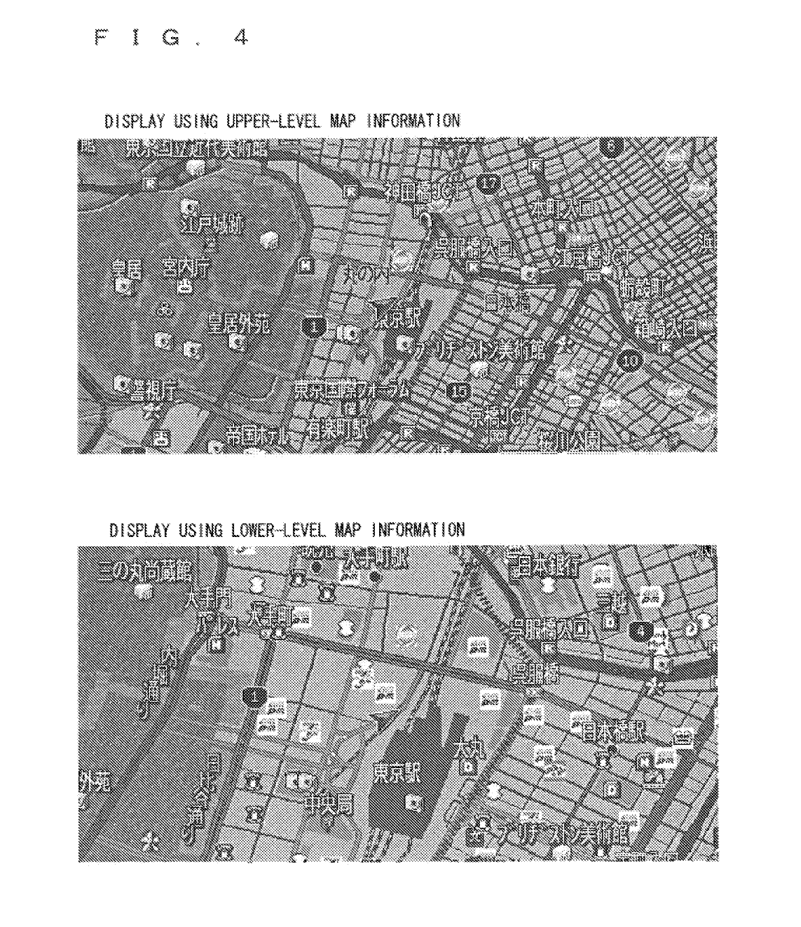

FIG. 4 shows an example to facilitate an understanding of the above concept.

FIG. 4 shows an example of a map displayed using upper-level map information (wide-range map information) and a map displayed using lower-level map information (narrow-range map information) on the basis of the map information shown in FIG. 3. As can be seen from FIG. 4, although map display information that is not displayed on the map using the upper-level map information is displayed, simply increasing the scale and changing the upper-level map information to the lower-level map information does not much change the amount of map display information on the display 16, i.e., the density of the map display information, because the display range is narrowed.

Here, the transition of display shown in FIG. 4 will be described on the basis of the structure of the map information. The lower-level map information includes more map display information than the upper-level map information as shown in the map displayed using the lower-level map information in FIG. 4. For example, the map using the lower-level map information displays icons for various convenience stores around Tokyo Station in FIG. 4, which are not displayed on the map using the upper-level map information. Here, the map of each level is constituted by a group of multiple sections called “parcels” as shown in FIG. 3. A single parcel (=500-meter square) of the lower-level map information is obtained by dividing a single parcel (=1-km square) of the upper-level map information into n (in the present example, four). If the display range of the display 16 is assumed to be a single parcel of each level, the display range (500-meter square) in the case of using the lower-level map information is narrower than the display range (1-km square) in the case of using the upper-level map information. Accordingly, if the scale is changed from small (1-km square) to large (500-meter square) to change the map using the upper-level map information to the map using the lower-level map information, it is possible to display map display information that is not displayed on the map using the upper-level map information, but, on the other hand, the range to be displayed on the display 16 is reduced from a 1-km square to a 500-meter square. Consequently, the density of the map display information to be displayed remains substantially unchanged.

In this case, since the range to be displayed is narrowed, the user will no longer be able to grasp a wide range of positional relationships indicated by the map display information regarding the area around the desired facility.

In view of this, Embodiment 1 makes it possible to increase the density of the map display information without changing the display range (1-km square) of the map as shown in FIG. 5.

FIG. 5 shows an example of a map displayed using upper-level map information and a map displayed using lower-level map information according to Embodiment 1. It can be seen from FIG. 5 that the map displayed using the upper-level map information and the map displayed using the lower-level map information have the same display range, but the density of the map display information is higher in the map displayed using the lower-level map information than in the map displayed using the upper-level map information. The display of the map using the lower-level map information in FIG. 5 is implemented by compressing n sections (in the example of FIG. 3, four sections) of the lower-level map information and displaying the compressed map information on the full screen of the display 16. In other words, a plurality of sections are compressed and displayed on the screen.

In the method proposed in Embodiment 1, a map displayed using upper-level map information and a map displayed using lower-level map information are used appropriately in order to change the density of the map display information as shown in FIG. 5. In other words, the map displayed using upper-level map information and the map displayed using tower-level map information are switched appropriately according to the purpose of map display selected by the user, making it possible to set the density of the map display information according to the purpose of map display.

For example, in the case of displaying the map 2.1 around the current location in FIG. 2, the map using the upper-level map information in FIG. 5 may be displayed, and in the case of displaying the map 2.4 around the desired facility as a result of screen transition according to a user instruction to change the map, the map using the lower-level map information in FIG. 5 may be displayed automatically at the time of the screen transition. This only requires the user to simply give an instruction to change display to a map according to purpose. When the user gives an instruction to change display to the map 2.1 around the current location, the user is able to obtain a recommended route or appropriate map display information in order to check conditions around the vehicle and thereby to drive smoothly. The density of the map display information at this time remains unchanged from the density of the map display information in the map information that corresponds to the scale currently used to display the map 2.1 around the current location.

On the other hand, when the user gives an instruction to change display to the map 2.4 around the desired facility, a method for changing the map currently being displayed to the map 2.4 around the desired facility and compressing four parcels of lower-level map information that is one level lower than the map information of the currently used scale to a full screen for display is used to increase the density of the map display information while maintaining the map display range. In this case, the map displays a large number of parking lots around the ABC restaurant and thus allows the user to find a desired parking lot.

Note that the above describes an exemplary case in which the scale used to display a 1-km square map is used in both cases of displaying the map 2.1 around the current location and the map 2.4 around the desired facility, in order to facilitate the understanding of Embodiment 1, but the scale used to display each map, i.e., the map display range, may be arbitrarily set to a range desired by the user.

In Embodiment 1, when the user gives an instruction to change display to a map according to purpose, not only the map but also the density of the map display information are automatically changed and displayed according to purpose. Note that the density of the map display information is preset according to the purpose of each map to be displayed. In other words, whatever scale the user selects as the map scale when display transitions to the map around a desired facility, the device may be configured to automatically compress and display a predetermined number of parcels (e.g., four parcels) of lower-level map information that is a predetermined number of levels (e.g., one level) lower than the map information of the currently selected scale. Accordingly, the functionality of Embodiment 1 is not lost even if the scale is arbitrarily changed by the user.

To describe this in accordance with the aforementioned example, when the user wants to change display of the map around a desired facility from a currently displayed 1-km square map to a 500-meter square map, four parcels of map information that is one level lower than the map information used to display the 500-meter square map and in which, for example, each parcel is a 250-meter square may be compressed and displayed on the display 16. This idea is applicable to whatever scale is selected by the user.

While the above describes the case of using lower-level map information that is one level lower than the currently selected map information when displaying the map around a desired facility on the display 16, it does not matter how many levels lower the lower-level map information is, as long as the lower-level map information is lower in level than the currently selected map information. For example, a plurality of parcels of map information that is two levels lower than the currently selected map information may be compressed and displayed.

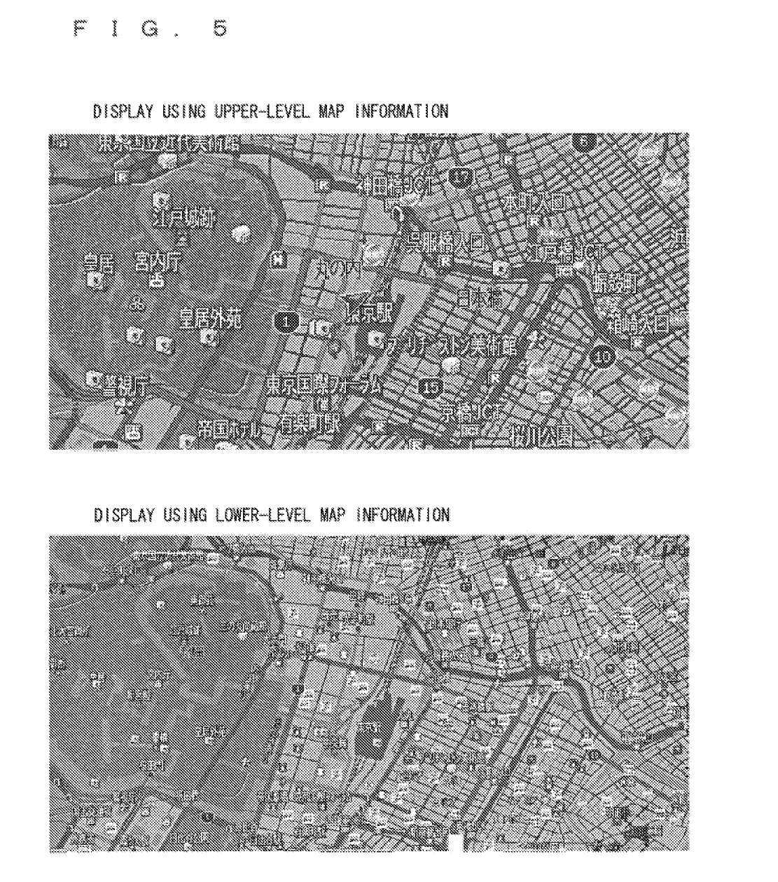

While the above describes the case in which the display range of the display 16 corresponds to a single parcel in order to simplify description, in actuality, the display range of the display 16 does not necessarily have to match a parcel of the map information as shown in FIG. 6.

FIG. 6 shows an example of the relationship between the map display range of the display 16 and a parcel of the map information. It can be seen from FIG. 6 that the display range of the display 16 does not always match a parcel of the map information.

Since the map displayed on the display 16 scrolls smoothly along with the movement of the vehicle, the map display range of the display 16 may span a plurality of parcels of the map information.

Referring back to FIG. 2, other examples of the screen transition will now be described. A touch switch “Return” that is set in the lower left part of the facility list screen 2.3 and a touch switch “Return” that is set in the lower left part of the map 2.4 around the desired facility both have the same function as the touch switch “Return” described with reference to the menu screen 2.2. They are used to return to the previous screen.

A touch switch “Destination” that is set in the lower right part of the map 2.4 around the desired facility is a switch for setting the location indicated by the cross cursor displayed on the screen as a destination. For example, by pressing the “Destination” switch in the map 2.4, it is possible to set the ABC restaurant as the destination, calculate a recommended route while displaying the map 2.1 around the current location, and display the calculated recommended route on the display 16.

Although a touch switch for direct transition from the map 2.1 around the current location to the map 2.4 around the desired facility is not shown in FIG. 2, for example, a touch switch “Display Map around Destination” may be set and displayed on the map 2.1 around the current location or in the menu screen 2.2. Alternatively, it may be determined based on a user instruction from the instruction input unit 10, such as being triggered by a user instruction to scroll around the current location of the map 2.1, that the user is searching for surrounding map display information using detailed map display information, at which time, display may be changed to use the same density of map display as the map 2.4 around the desired facility and may transition to a state of manually scrolling on a map displayed in a compressed state, like the map in the lower part of FIG. 5. This function is useful for a user who is getting closer to a desired facility to visually search for that facility by scrolling the map without using the function of facility search.

The map 2.5 of the entire route displays the whole map of the calculated recommended route. Display transitions to this map 2.5 by pressing the “Display Entire Route” button that is set and displayed on the menu screen 2.2. At this time, a desired scale is automatically selected according to the remaining distance from the current location of the vehicle to the destination. Specifically, among scales in which both of the current location of the vehicle and the destination can be displayed on the screen of the display 16, a scale at which the distance between the current location of the vehicle and the destination is the longest on the display 16, i.e., a scale at which the full screen of the display 16 is used, is automatically selected. Since the remaining distance decreases quickly as the vehicle travels along, a desirable level of map information is automatically selected according to the remaining distance on the scale. In Embodiment 1, the density of the map display information used to display the map of the entire route remains unchanged from the density of the map display information included in the map information of a level that corresponds to the selected scale.

Note that display transitions to the menu screen 2.2 by pressing a “Return” button that is set and displayed in the lower right part of the map 2.5 of the entire route. Alternatively, a touch switch “Display Map around Current Location” may be provided on the map 2.5 so that display can directly transition to the map 2.1 around the current location.

Next, the procedure for processing will be described with reference to a flowchart.

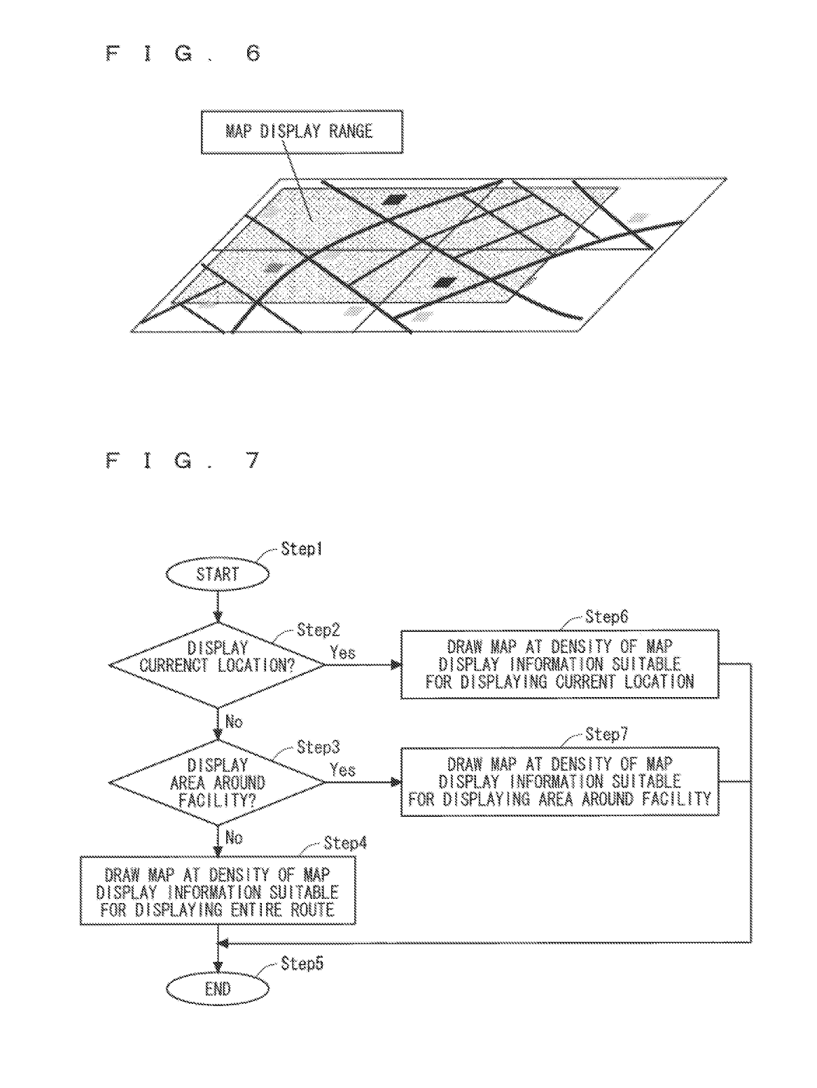

FIG. 7 is a flowchart of processing for determining the density of the map display information used to draw a portion of a map displayed on the screen, performed by the map display control device 1, out of screen drawing processing performed triggered by receipt of a user instruction to change display to a map according to purpose.

First, processing of Step 1 is started triggered by input of a user instruction to change display via the instruction input unit 10. Note that, in the case of initial power activation, an arbitrary map such as the map 2.1 around the current location may be displayed as an initial setting. Of course, any other maps may instead be used as the initial map.

When the processing of Step 1 is started upon receipt of a user instruction to change display via the instruction input unit 10, it is determined in Step 2 whether or not the map instructed to be drawn on the display 16 is the map 2.1 around the current location in FIG. 2.

If the determination result shows that the instruction is to display the map 2.1 around the current location, the procedure proceeds to Step 6 in which an instruction signal to draw a map at the density of map display information that is suitable for displaying the map 2.1 around the current location is output from display controller 15. Here, the density of map display information suitable for displaying the map around the current location is set in the map drawing unit 141. For example, the density of map display information of the level of the map information that corresponds to the scale currently selected to display the map 2.1 around the current location is used as is.

If it is determined in Step 2 that the instruction is not to display the map 2.1 around the current location, it is determined in Step 3 whether or not the instruction is to display the map 2.4 around the desired facility in FIG. 2.

If the determination result shows that the instruction is to display the map 2.4 around the desired facility, the procedure proceeds to Step 7 in which an instruction to draw a map at the density of map display information that is suitable for displaying the map 2.4 around the desired facility, i.e., an instruction to draw a map in accordance with the density of map display information that is set according to the purpose of displaying the map 2.4 around the desired facility, is output from the display controller 15. Here, the instruction signal output from the display controller 15 is computed by the information drawing unit 14.

Specifically, as described above, the map drawing unit 141 obtains lower-level map information that is a predetermined number of levels lower than the map information on the scale currently used for the map 2.4 around the desired facility, and processes the obtained lower-level map information by compressing a predetermined plurality of parcels of the lower-level map information to enable full screen on the display 16. This makes it possible to increase the density of map display information without changing the display range of the map displayed on the display 16.

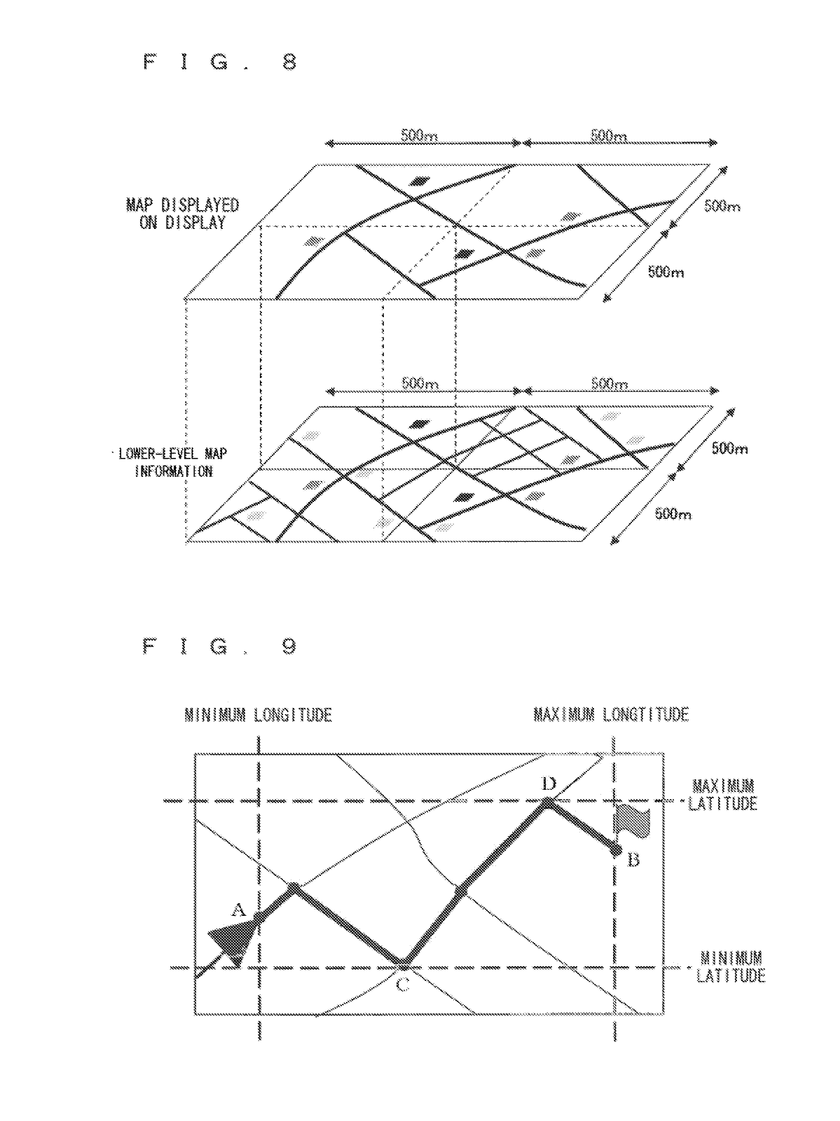

FIG. 8 shows an example of a case where four parcels of lower-level map information that is one level lower than the map information corresponding to the currently used scale are compressed to fit the display range of the display 16.

In FIG. 8, it is assumed that a scale at which a 1-km square area is displayed on the full screen is used for the map 2.4 around the desired facility. It is also assumed that the density of map display information that is set according to the purpose of displaying the map 2.4 around the desired facility is set so as to compress and display lower-level map information that is one level lower than the map information corresponding to the currently used scale.

Based on this assumption, when the scale at which a 1-km square area is displayed on the full screen is selected to display the map 2.4 around the desired facility, map information that is one level lower than the map information used to display the map 2.4 around the desired facility and where each parcel is a 500-meter square is used. Then, four parcels of the one-level lower map information, each parcel being is a 500-meter square, are used for processing in which the four parcels are compressed to a quarter of their size so as to fit the display range of the currently used scale at which a 1-km square area is displayed on the full screen. The processing of Step 7 is automatically performed upon receipt of a user instruction to change display to the map 2.4 around the desired facility. This is because it can be estimated that the user who has selected the map 2.4 around the desired facility as the purpose of map display requires a map that has a high density of map display information. Thus, the map drawing unit 141 is configured to automatically perform the aforementioned processing when the user gives an instruction to change display to the map 2.4 around the desired facility.

In Embodiment 1, if the map to which display is changed is the map 2.4 around the desired facility, the density of the map display information is automatically set such that four parcels of map information that is one level lower than the map information on the scale selected to display the map 2.4 around the desired facility are compressed to fit the screen. However, the user may require the density of the map display information to be changed depending on whether the area 2.4 around the desired facility is in a city or in the countryside. Also, different users have different preferences. It is thus desirable to separately provide a switch that allows the user to preset the density of the map display information to be applied when the map to be displayed is changed, or to modify the initial settings.

For example, two types of switches, namely “More Detail” and “Less Detail,” may be provided so that the user is capable of adjusting the level of the map information for use in auto-compression according to the user's preference. Specifically, in the case where it is assumed that the map information for use in auto-compression is two levels lower than the map information of the currently used scale, if the “More Detail” switch is pressed once, map information that is three levels lower than the map information of the currently used scale may be used from the next instruction to change display, and if the “Less Detail” switch is pressed once, map information that is one level lower than the map information of the currently used scale may be used from the next instruction to change display. Note that the display range of the display 16 will not be changed by these operations.

As described above, by simply giving an instruction to change display from the map 2.1 around the current location to the map 2.4 around the desired facility, the user can automatically obtain a map using the lower-level map information in FIG. 5 rather than a map using the upper-level map information in FIG. 5.

In Embodiment 1, there is no need to separately provide new map information or the like because of simply switching using the plurality of levels of map information pieces originally stored in the map information storage 71 appropriately. Accordingly, there is also no need to expand the memory capacity in order to store map information.

It goes without saying that simply compressing four parcels of lower-level map information will result in display of a map that is difficult to read due to overlapping or concentration of pieces of the map display information.

In view of this, as in the case of displaying the map using the lower-level map information in FIG. 5, such a difficult-to-read map is converted into an easy-to-read map (1) by changing various types of character information such as the names of places, facilities, and intersections, i.e., the character size, (2) by changing the sizes of various icons indicating facility numbers, road numbers, or the like, and (3) by reducing the widths of roads indicated by the thicknesses of road lines such as general roads and highways. In other words, at least one of various icons, road widths, and characters are adjusted. Embodiment 1 describes the case of reducing the amount of map display information. On the other hand, Embodiment 2 will describe below a case of expanding map information, and therefore the amount of map display information may be increased in Embodiment 2.

Although not employed in FIG. 5, a method may be used in which the display positions of at least either various icons or characters in the map display information may be changed according to the density of the map display information used to display the specified map. As another alternative, the display angles of at least either various icons or characters in the map display information may be varied by rotating the icons and characters according to the density of the map display information used to display the specified map, in order to facilitate reading of the map.

Referring back to the flowchart in FIG. 7, in Embodiment 1, if it is determined in Steps 2 and 3 that the instruction is neither to display the map 2.1 around the current location nor to display the map 2.4 around the desired facility, this indicates that the instruction is to display the map 2.5 of the entire route.

Thus, in Step 4, the recommended route from the current location of the vehicle detected by the current location detector 5 and the destination set via the instruction input unit 10 is taken into consideration to select map information of a scale at which the recommended route from the current location of the vehicle to the destination fits in the screen of the display 6 and the recommended route is displayed as large as possible on the display 16, i.e. map information of a scale at which the recommended route can be displayed on the full screen. Such map information of a scale at which both of the current location of the vehicle and the destination can be displayed on the full screen will change with a change in the recommended route as the vehicle travels along.

Accordingly, when the user gives an instruction to change display to the map 2.5 of the entire route, the map drawing unit 141 performs computation so that map information on an appropriate scale is automatically selected in Step 4 for display, and the display controller 15 outputs an instruction signal. This allows the user to always check the current location of the vehicle and the location of the destination on a map having an appropriate display range as well as to check the recommended route from the current location to the destination. Since it is presumed that the amount of map display information required at this time is not that great, the density of the map display information included in the map information on the selected scale may be used.

The above describes the case of selecting map information of a scale at which the current location of the vehicle, the destination, and the recommended route therebetween can be displayed on the full screen. Now, a specific example of implementing this will be described.

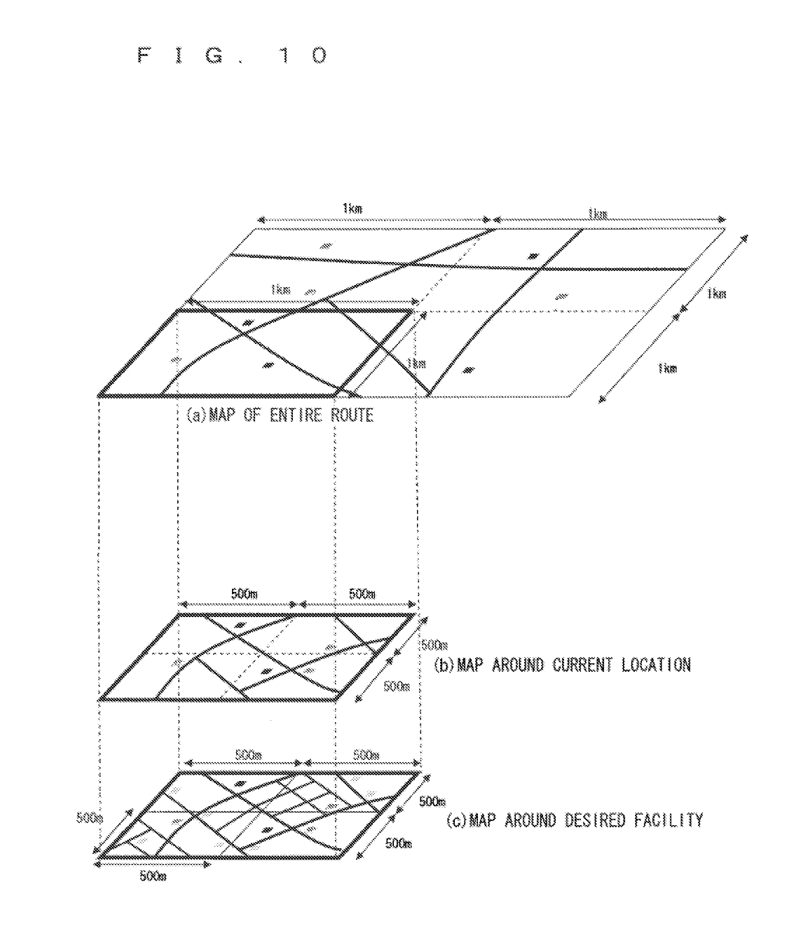

FIG. 9 is a diagram illustrating a recommended route out of the entire route indicated by links serving as line segments and nodes serving as points.

FIG. 9 shows a map where the upper side is north in the Northern Hemisphere. At this time, a node A is a point having the minimum longitude on the entire route, and a node B is a point having the maximum longitude. Similarly, a node C is a point having the minimum latitude, and a node D is a point having the maximum latitude. Here, by taking the four points respectively having the minimum longitude, the maximum longitude, the minimum latitude, and the maximum latitude on the entire route, a rectangular area indicated by the broken line in FIG. 9 is obtained.

Thus, a scale where the display range of the display 16 is slightly larger than the obtained rectangle shown in FIG. 9 may be selected, in order to select map information of a scale at which the current location of the vehicle and the destination can be displayed on the full screen. A margin may be provided by setting the size of the rectangle to, for example, 95% or less of the display range of the display 16.

Note that the above calculation is conducted by the map drawing unit 141 on the basis of the current location of the vehicle detected by the current location detector 5, point information regarding the destination that is set via the instruction input unit 10, the recommended route calculated by the route calculator 12 on the basis of the current location of the vehicle and the point information, and the map information, obtained from the map information storage 71, that includes information regarding links and nodes corresponding to the recommended route. As described above, in the case of the map 2.5 of the entire route, the scale increases as the remaining distance to the destination decreases, and the density of the map display information may be the density of the map display information included in the map information on the scale used at that point.

After the processing of Step 6, 7, or 4 has ended, the flowchart in FIG. 7 ends in Step 5, and the procedure prepares for the next user instruction.

Note that the currently selected map may be stored as last memory in Step 5 and used on the next activation.

Although Embodiment 1 describes typical three types of purposes as the purposes of map display, various other purposes of map display are conceivable, such as displaying the area around the destination, displaying the area around the user's house, displaying an area on route to the destination, and displaying a wide-area map on a city, town or village basis. The density of the map display information may be set for each of these purposes of map display, and at the time of screen transition to any map, the preset density of the map display information may be used to automatically display the map.

### Embodiment 2

Embodiment 1 above describes an example in which a plurality of parcels of map information that are lower in level than map information on the scale used for the map being displayed are compressed and displayed so as to increase the density of the map display information without changing the display range of the display 16.

In contrast to Embodiment 1, Embodiment 2 describes an example in which map information that is higher in level than map information on the scale used for the map being displayed is used to reduce the density of the map display information without changing the display range of the display 16.

One example of the case where it is desirable to reduce the density of the map display information that has been set according to the purpose of map display is where the user feels that too much map display information is displayed on the display 16.

For example, in the case of the map 2.5 of the entire route described in Embodiment 1, setting are made so that the density of the map display information remains the same as the density of the map display information included in map information on the selected scale. However, there is the possibility that almost no map display information is required on that map, and map display information having a lower density is required.

In view of this, in Embodiment 2, when the user gives an instruction to change display to the map 2.5 of the entire route, not only is map display changed but the density of the map display information is also automatically reduced to be lower than the density of the map display information included in map information on the selected scale.

FIG. 10 shows an example in which a quarter of a parcel of map information that is one level higher (upper-level map information in FIG. 10) than map information of the currently selected scale (middle-level map information in FIG. 10) is expanded to fit the display range of the display 16. In FIG. 10, the upper-level map information is map information where each parcel is a 2-km square, the middle-level map information is map information where each parcel is a 1-km square, and lower-level map information is map information where each parcel is a 500-m square.

In Embodiment 2, the density of the map display information is reduced when the map (a) of the entire route, which is enclosed by the bold frame in FIG. 10, is displayed on the screen of the display 16. In other words, it is assumed that the map information of the currently selected scale is the middle-level map information. At this time, the map display control device cuts a quarter (1-km square) out of one parcel (2-km square) of the map information that is one level higher. Then, the map display control device expands this quarter of a parcel of the map information to the full screen size of the display 16 and displays the quarter of a parcel of the map information on the full screen. Accordingly, the map (a) of the entire route is displayed using the map information that is one level higher, and therefore it is possible to reduce the density of the map display information without changing the display range of the display 16.

Similarly, a map (b) displays the map around the current location to fit the screen of the display 16. In FIG. 10, the middle-level map information is map information where each parcel is a 1-km square. In this case, a 1-km square serving as one parcel is displayed as-is to fit the screen of the display 16. Note that a scale for displaying a 1-km square is selected as the scale of the map (b) around the current location.

A map (c) displays a map around the desired facility to fit the screen of the display 16. In FIG. 10, the lower-level map information is map information where each parcel is a 500-meter square, and is originally used to display a 500-meter square to fit the screen of the display 16. However, in the case of displaying the map (c) around the desired facility, four 500-meter squares, each being a single parcel, are collected, compressed, and displayed to fit the screen of the display 16 in order to increase the density of the map display information as described in Embodiment 1. It is assumed here that a scale for displaying a 1-km square is selected as the scale of the map (c) around the desired facility.

As is clear from FIG. 10, (a) the map of the entire route, (b) the map around the current location, and (c) the map around the desired facility all have the same display range of a 1-km square, but they are displayed using different levels of the map information and thus can have different densities of the map display information.

Note that, in the case of the map 2.5 of the entire route, the scale to be automatically selected on the basis of the size of the aforementioned rectangle increases (displays a smaller area) as the remaining distance between the current location of the vehicle and the destination decreases, but by expanding part of map information that is one level higher than the map information on the automatically selected scale, it is possible to always obtain a map having a reduced density of map display information.

The densities of map display information, which are set according to various purposes of map display, may be preset in association with various types of maps in the map drawing unit 141. Alternatively, the densities of the map display information for various types of maps may each have a recommended initial value set in the map drawing unit 141, and these initial values may be made adjustable in accordance with a user instruction from the instruction input unit 10.

Note that the map 2.5 of the entire mute according to Embodiment 2 may be used, instead of the map 2.5 of the entire route according to Embodiment 1.

The above description of Embodiments 1 and 2 are given on the assumption that the map information storage 71 stores the most up-to-date map information, and description regarding updating of the map information has been omitted. However, the actual map information keeps changing as new facilities or roads are built or removed.

Thus, a brief description is given regarding addition, partial updating, partial deletion, full deletion, and fully updating of map information stored in the map information storage 71.

As described above, the map information stored in the information storage 7 can be changed. Specifically, changes to the map information, such as partial updating, partial addition, partial deletion, full deletion, and fully updating, can be made by the information updating unit 8 upon receipt of an instruction of the control unit 2. As already described, the information input unit 9 is configured to supply the map information or the AV information to the on-board navigation composite device.

Thus, the control unit 2 receives the most up-to-date map information from the aforementioned information media (media having a function to provide information to the information input unit 9, examples of which include disk media, semiconductor media, and portable media, and media having a function to use communication functionality, which will be described below, to provide information to the information input unit 9 are collectively referred to as “information media”).

When a user instruction for “fully updating” is received via the instruction input unit 10, the control unit 2 that has received the map information from an information medium via the information input unit 9 fully deletes the map information stored in the map information storage 71 and writes new map information stored in the information medium, or overwrites the map information stored in the map information storage 71 with the new map information. This processing for changing data is executed by the information updating unit 8 upon receipt of an instruction from the control unit 2.

In the case of “partial changes” such as partial updating, partial addition, or partial deletion, there are two methods, namely “manual change” that is made in accordance with a user instruction, and “auto change.” In the case of “manual change,” a range that the user wants to change, e.g., a range on a city, town, village, or prefecture basis, may be selected, and only the selected and desired range of the map information in the map information storage 71 may be modified on the basis of information regarding changes recorded in the information medium.

In the case of “auto change,” determining a priority order for ranges to be changed is left to the control unit 2. For example, firstly if there is a change to a range of several kilometers (e.g., 10 km) centering on the current location of the vehicle, the map information is updated to reflect this change, secondly the map information is updated to reflect a change to a range of several kilometers along the current recommended route (e.g., 2 km on the right and left of the recommended route), and finally the map information is updated to reflect a change to a range of several kilometers (e.g., 10 km) centering on the destination and a change to a range of several kilometers (e.g., 10 km) centering on the user's house. With this method, all the information regarding changes obtained from the information medium is not always reflected, but necessary information regarding the progress of the vehicle can at least be updated. Note that the priority order and the range to be changed in the case of “auto change” are not limited to the examples described above.

While the above describes a method for exchanging information between the information input unit 9 and the information medium, the information medium may be used as a communication device to exchange the map information with a separately created information center. Alternatively, the information input unit 9 may include a communication device for exchanging information with an information center and use this communication device to exchange the aforementioned map information, traffic information, or AV information. Instead of including such a communication device, the information input unit 9 may use the aforementioned portable information communication device as an information medium.

At this time, information transmitted from the vehicle to the information center may be the current version of the map information stored in the map information storage 71, and if there is new map information in the information center, the new map information may be downloaded automatically or in accordance with a user instruction.

In the above description, the on-board navigation composite device may operate independently on the basis of the map information stored in the map information storage 71, or may operate using a communication system, in which case a necessary range of the map information is obtained by communication when necessary and is temporarily stored for use.

Here, the necessary range of information refers to, for example, map information regarding the area around the current location of the vehicle, the recommended route, and the area around the desired facility. In this case, new map information is always obtained for use from the information center. This saves the trouble of updating the old map information. For example, in the case of displaying the map around the current location, a map consisting of nine parcels of map information of the currently used scale, centered on the current location of the vehicle, may be downloaded and temporarily stored in a work memory device such as a DRAM for use in display, and a map displaying a new range may be obtained as the vehicle travels along, and the portion of the map already driven through may be deleted. Note that, for the aforementioned auto-compression or auto-expansion of the map to be displayed on the display, the map information of the currently used scale is not enough by itself and it is necessary to download lower-level map information or upper-level map information regarding the range corresponding to the portion to be auto-compressed or auto-expanded.

While the above describes the updating of map information, the AV information stored in the AV information storage 72 can also be updated in a similar manner and can be changed using an information medium or by communication.

As described above, in the above embodiments, the map display control device includes a map information storage that stores map information including map display information to be displayed on a display, an instruction input unit that is capable of receiving input of a user instruction that includes an instruction to change display to a map according to purpose, an information drawing unit that is capable of setting a density of the map display information according to the purpose of the map, and processes the map information in accordance with the map and the density of the map display information set according to the purpose of the map, on the basis of the instruction to change display, and a display controller that outputs an instruction signal on the basis of an instruction from the information drawing unit to display the map instructed to be displayed on the display at the density of the map display information that is set according to the map. It is thus possible to output an instruction signal on the basis of a user instruction to change display to a map according to purpose so that information is displayed on the display in accordance with the map and the density of the map display information that is set according the purpose of map display.

In the above-described embodiments, the map display control device includes a current location detector that specifies a current location on the basis of a signal received from a sensor for detecting the current location, a facility search unit that searches for a desired facility on the basis of a user instruction from the instruction input unit, and an information drawing unit that processes the map information to display at least either a map around the current location or a map around the desired facility on the display on the basis of an instruction from the instruction input unit. The information drawing unit increases a density of map display information to be displayed on the map around the desired facility higher than a density of map display information used to display the map around the current location for display. It is thus possible to know details of the map display information used to display the map around the desired facility, including mutual positional relationships.

In the map display control device of the above-described embodiments, the map information storage includes various icons, road widths, and characters as the map display information, and the information drawing unit is configured to adjust a size of at least one of various icons, road widths, and characters among the map display information to be displayed in accordance with the density of the map display information for the map instructed to be displayed, or to adjust a display position or angle of the characters in accordance with the density of the map display information for the map instructed to be displayed. It is thus possible to obtain a map that is easy to read even if the density of the map display information is increased.

In the map display control device of the above-described embodiments, the information drawing unit is configured to even if an instruction to change a scale of the map being displayed is input from the instruction input unit, maintain the density of the map display information displayed before the change of the scale. It is thus possible to maintain the desired density of the map display information even if the scale of the map being displayed is changed.

In the map display control device of the above-described embodiments, the map information stored in the map information storage is a hierarchical set of a plurality of map information pieces that correspond respectively to different scales, and each of the map information pieces for each scale is constituted by a plurality of sections, and the information drawing unit is configured to, upon receiving an instruction to display the map around the desired facility, increase the density of the map display information by using map information that is of a more detailed level than a map scale used for the map around the desired facility and compressing a plurality of sections of the map information of the more detailed level for display in a screen. This eliminates the need to provide new map information in order to increase the density of map display information.

In the above-described embodiments, the map display control device includes a map information storage that stores map information including map display information to be displayed on a display, an instruction input unit that is capable of receiving input of a user instruction that includes an instruction to change display to a map according to purpose, an information drawing unit that is capable of setting a density of the map display information according to the purpose of the map, and processes the map information in accordance with the map and the density of the map display information set according to the purpose of the map, on the basis of the instruction to change display, a display controller that outputs an instruction signal on the basis of an instruction from the information drawing unit to display the map instructed to be displayed on the display at the density of the map display information that is set according to the map, and a display that displays information upon receiving an instruction signal from the display controller. It is thus possible to, on the basis of a user instruction to change display to a map according to purpose, display information on the display in accordance with the map and the density of the map display information that is set according the purpose of map display.

While embodiments of the invention and variations on the embodiments have been described, it is to be understood that combination of any of the embodiments or modification, replacement or deletion of any of the constituent elements is possible without departing from the scope of the invention.

While the above embodiments describe a map display control device and a navigation device using the map display control device, there are various types of navigation devices such as a navigation device for mobile units that is mounted in mobile units such as cars, ships, and airplanes, a personal navigation device (PND) that can be removed from or mounted in such mobile units, and portable terminals having navigation functionality such as mobile phones or tablets that people (as a kind of mobile unit) carry around with them. The map display control device and the navigation device using the map display control device are also applicable to audio devices or AV devices that operate in cooperation with the aforementioned devices.

### DESCRIPTION OF REFERENCE NUMERALS

1 Map display control device
2 Control unit
3 GPS receiver
4 Self-contained navigation sensor
5 Current location detector
6 Traffic information transmitter/receiver
7 Information storage
8 Information updating unit
9 Information input unit
10 instruction input unit
11 Facility search unit
12 Route calculator
13 Guidance unit
14 Information drawing unit
15 Display controller
16 Display
17 Audio controller
18 Speaker

1-6. (canceled)

7. A map display control device comprising:
an instruction input unit that is capable of receiving input of a user instruction that includes an instruction to change display to a map according to purpose;
an information drawing unit that acquires a map information including map display information to be displayed on a display, is capable of setting a density of said map display information according to said purpose of said map, and processes said map information in accordance with said map and the density of said map display information set according to said purpose of said map, on the basis of said instruction to change display; and
a display controller that outputs an instruction signal on the basis of an instruction from said information drawing unit to display said map as changed on said display at the density of said map display information that is set according to said purpose of said map,
wherein said information drawing unit automatically changes the density of said map display information according to said purpose of said map that said user instructs using said instruction input unit.

8. The map display control device according to claim 7, further comprising a map information storage that stores said map information.

9. The map display control device according to claim 7, comprising:
a current location detector that specifies a current location on the basis of a signal received from a sensor for detecting the current location;
a facility search unit that searches for a desired facility on the basis of a user instruction from said instruction input unit; and
an information drawing unit that processes said map information to display at least either a map around the current location or a map around said desired facility on said display on the basis of a user instruction from said instruction input unit,
wherein said information drawing unit performs a process in which a density of map display information displayed on the map around said desired facility is higher than a density of map display information displayed on the map around said current location.

10. The map display control device according to claim 9, wherein
said map information includes various icons, road widths, and characters as the map display information, and
said information drawing unit is configured to adjust a size of at least one of various icons, road widths, and characters among the map display information to be displayed in accordance with the density of the map display information for said map instructed to be displayed, or to adjust a display position or angle of said characters in accordance with the density of the map display information for said map instructed to be displayed.

11. The map display control device according to claim 10, wherein
said information drawing unit is configured to, even if an instruction to change a scale of said map being displayed is input from said instruction input unit, maintain the density of the map display information displayed before the change of said scale.

12. The map display control device according to claim 9, wherein
said map information is a hierarchical set of a plurality of map information pieces that correspond respectively to different scales, and each of the map information pieces for each scale is constituted by a plurality of sections, and
said information drawing unit is configured to, upon receiving an instruction to display the map around said desired facility, increase the density of the map display information by using map information that is of a more detailed level than a map scale used for the map around said desired facility and compressing a plurality of sections of the map information of the more detailed level for display in a screen.

13. A navigation device comprising:
a map information storage that stores map information including map display information to be displayed on a display;
an instruction input unit that is capable of receiving input of a user instruction that includes an instruction to change display to a map according to purpose;
an information drawing unit that is capable of setting a density of said map display information according to said purpose of said map, and processes said map information in accordance with said map and the density of said map display information set according to said purpose of said map, on the basis of said instruction to change display;
a display controller that outputs an instruction signal on the basis of an instruction from said information drawing unit to display said map as changed on said display at the density of said map display information that is set according to said purpose of said map; and
a display that displays information upon receiving an instruction signal from the display controller,
wherein said information drawing unit automatically changes the density of said map display information according to said purpose of said map that said user instructs using said instruction input unit.
